(19) United States
(12) Patent Application Publication
(10) Pub. No.: US 2026/0260378 A1
(43) Pub. Date: Sep. 3, 2026

(54) METHODS AND SYSTEMS FOR VISUALLY DETERMINING THE STATE OF A MACHINE LINE

(71) Applicant: Krones AG, Neutraubling (DE)

(72) Inventors: Simran JAVIR, Neutraubling (DE); Ahmad ALSHEIKH, Neutraubling (DE); Thomas ALBRECHT, Beilngries (DE)

(21) Appl. No.: 19/549,565

(22) Filed: Feb. 25, 2026

(30) Foreign Application Priority Data
Mar. 3, 2025 (DE) 102025107971.4

(51) Int. Cl. G06T 7/73; G06T 7/11

(52) U.S. Cl. CPC G06T 7/75; G06T 7/11; G06T 2207/10016; G06T 2207/20024; G06T 2207/20081; G06T 2207/20092; G06T 2207/30128

(57) ABSTRACT

The present disclosure relates to various methods and systems for generating control parameters of a machine line, in particular a machine line for filling and packaging food and/or beverages. The present disclosure presents a new approach to the precise analysis of occupancy levels in filling systems by using modern, transformer-based AI models. The various models developed for this purpose include, for example, a segmentation model, a similarity model and an object recognition model, each of which is connected to an image source, such as a video stream, and can assess a state of a machine line in real time and react thereto. Possible states that can be recognized by the system include, for example, an occupancy level of the transport portion, a number of beverage containers on the transport portion, a congestion of the beverage containers on the transport portion, and/or an anomaly of one or more beverage containers.

### CROSS REFERENCE TO RELATED APPLICATION

The present application claims priority to German Patent Application No. 10 2025 107 971.4 filed on March 03, 2025. The entire contents of the above-listed application are hereby incorporated by reference for all purposes.

### TECHNICAL FIELD

The disclosure relates to methods and systems for generating control parameters of a machine line, for example a machine line for filling and packaging food and/or beverages.

### BACKGROUND

The increasing automation and efficiency gains in industrial processes result in that machine lines, such as filling systems for beverages and food, are becoming increasingly complex. In modern filling plants, precise control of machine performance and transport speed is of paramount importance in order to ensure high productivity while avoiding production disruptions. Detecting and assessing occupancy levels along the conveyor and buffer segments is essential for such control. Occupancy levels serve as a basis for decisions regarding adjustments to machine performance and the speed of transport means in order to ensure a consistent material flow situation.

### SUMMARY

Traditionally, the assessment of occupancy levels in filling systems is based on the use of conventional sensors that are strategically positioned along the conveyor and buffer segments in order to monitor and regulate machine operations. By recording occupancy data, the sensors enable control of the output capacity of the machines and the speed of the transport means. Accurately measured occupancy levels are important to avoid congestion and accumulation of containers in specific regions by making timely adjustments to machine performance or transport speed.

An alternative technology for measuring occupancy levels uses machine vision models such as image segmentation and object recognition using conventional AI. These approaches use camera systems and algorithms to analyze visual data and derive information about occupancy levels.

However, despite their widespread use, traditional sensor-based methods have some disadvantages. In particular, in transport means or buffer systems with multiple lanes or complex geometries, the sensors cannot provide precise measurements, as the sensors can only ever cover specific regions. This leads to inaccurate occupancy data, which negatively affect the efficiency of the overall system. The consequences of such inaccuracies lead to inefficient machine control, transport disruptions, which can cause congestion or damaged products, or even production losses.

While available machine vision models offer a more accurate measurement of occupancy levels over a larger range, they are associated with high costs and effort. Their implementation requires several steps, including data collection, model training, and continuous adaptation to new products or changing environmental conditions, such as different lighting conditions. For example, systems trained using conventional neural networks require new training data for every change in production (e.g., new products, new bottle design, etc.) and must be "retrained." These requirements make the technology time- and resource-intensive, which limits its widespread practical application.

There is hence a need for improved systems and methods for generating control parameters of a machine line.

The object is achieved by the systems and methods described herein.

One embodiment relates to a system for generating control parameters for a machine line, for example for a machine line for filling and packaging food and/or beverages. The system comprises the machine line, an image source for providing video frames of a recording of the machine line, and a computer apparatus comprising a processor and a memory connected to the processor. The computer apparatus is configured to provide and execute various modules. A first module is a segmentation model that receives video frames from the image source and segments and classifies a large number of objects in a first video frame. A second module is a prompt encoder that is functionally linked to the segmentation model and makes a selection of classified objects in the first video frame. A first classified object is a transport portion of the machine line, and a second classified object is a beverage container on the transport portion of the machine line. A third module is a tracker that identifies and tracks all object instances from the class of selected classified objects in at least one subsequent video frame. According to an exemplary embodiment, the segmentation model comprises an image encoder that analyzes the input image, e.g., the video frame, and extracts its key functions (features). A point decoder can then be supplied with a grid of key points that consists of a 2D array and covers the entire image of the video frame. These points can be automatically assigned and encoded along with the video frame. Each key point can correspond to a potential position of an object or part thereof. The point decoder can use a pre-trained segmentation model to locate possible objects in the video frame. The information from the image encoder and the point decoder can be combined in a mask decoder to generate a mask that precisely outlines all objects in the image. The processor can then determine a state of the machine line based on the tracker data and generate control parameters for the machine line based on the determined state of the machine line.

In one exemplary embodiment, it is also possible to use a traditional segmentation model which has been trained on a general dataset that has a standardized network architecture (convolutional neural network). This traditional segmentation model can then be retrained for new objects and/or lighting conditions, for example to be adapted to special containers and/or special environmental conditions.

Another embodiment relates to a system that also comprises the machine line, an image source for providing video frames of a recording of the machine line, and a computer apparatus comprising a processor and a memory connected to the processor. In this embodiment, the computer apparatus provides a similarity model that comprises an image encoder. The similarity model receives a first video frame from the image source and defines a visual representation of one or more target objects. The model then encodes the first video frame along with the visual representation of the one or more target objects. During encoding, the first video frame is first divided into a grid of rectangular regions, and features are extracted from each of the extracted rectangular regions. Features can include, for example, color regions, contours, shapes, edges, etc. A density value is then determined for each of the extracted rectangular regions. Such density value determination is based on a similarity of the corresponding rectangular region to the visual representation of the one or more target objects or part thereof. Next, a density map is determined for the video frame. Once the encoding is complete with the creation of the density map, the density map can be converted by the processor into a distribution of an actual number of target objects within the specific region of the machine line, before corresponding control parameters are generated based on the actual number of target objects.

Another embodiment relates to a system that also comprises the machine line, an image source for providing video frames of a recording of the machine line, and a computer apparatus comprising a processor and a memory connected to the processor. In this embodiment, the computer apparatus provides an object recognition model. The model consists of an image encoder that analyzes the input image and extracts its key functions (features). A point decoder is then supplied with a grid of key points that consists of a 2D array and covers the entire image. These points are automatically assigned and encoded along with the image. Each key point can correspond to a potential position of an object or part thereof. The point decoder can use a pre-trained segmentation model to locate possible objects in the video frame. The information from the image encoder and the point decoder are combined in a mask decoder to generate a mask that precisely outlines all objects in the image. The created masks are then classified and filtered based on a selection of a representation of one or more target objects. The filtered classification selects only the class of the one or more target objects. Based on the filtered classification, a number of target objects and a state of the machine line are then determined in order to generate control parameters for the machine line.

According to one exemplary embodiment, the three embodiments described above require a prompt (i.e., a specific target object) to find the encoded image/video. However, the embodiments can also be integrated into a logical concept that can automatically define the prompt points (or target objects) for transport and mass flow, thus providing a model that requires no further user input and only a video or live stream frame for the model. The model will then begin to mask the mass flow and transport without requiring any further training or intervention.

The embodiments described above can each be used to detect an occupancy level of the transport portion, and/or a number of beverage containers on the transport portion, and/or a congestion of the beverage containers on the transport portion, and/or an anomaly of one or more beverage containers, and to react accordingly by generating control parameters.

Other embodiments relate to corresponding methods that can be carried out by a computer apparatus.

### BRIEF DESCRIPTION OF THE FIGURES

Example aspects of the disclosure are shown in the drawings. In the figures:

FIG. 1: shows an image recording made by a video camera of a transport portion of a filling plant;

FIG. 2: shows the image recording processed by the techniques and AI models described herein;

FIG. 3: shows an exemplary representation of a section of a density map;

FIG. 4: shows an exemplary plant configuration for PET containers and adhesive containers;

FIG. 5: shows an exemplary plant configuration for PET containers and shrink packers;

FIG. 6: shows an exemplary plant configuration for cans or glass bottles;

FIG. 7: shows an exemplary plant configuration for cans; and

FIG. 8: shows an exemplary system configured for implementing the various models.

### DETAILED DESCRIPTION

The present disclosure presents a new approach to the precise analysis of occupancy levels in filling systems by using modern, transformer-based AI models. These models use a new artificial intelligence concept, the so-called self-attention mechanism, which was originally developed for natural language processing. According to the present disclosure, these models are used for the analysis of image or video data in order to draw precise conclusions about a state of the machine line and for example the transport system, such as the occupancy level. This is also possible in highly complex production environments, without the need to specifically train the models for such tasks or image types beforehand.

Transformer models are advanced concepts in the field of AI that are based on the principle of self-attention, which allows a model to recognize relationships between the individual parts of an input dataset, such as words in a text or pixels in an image. Unlike conventional neural networks, which often process inputs sequentially, transformer models allow for parallel processing of large amounts of data. This allows them to identify and analyze both local and global patterns in the data.

The self-attention mechanism is particularly powerful because it assigns a so-called attention value to each part of the input data and assesses its relevance in the context of the entire dataset. In this way, transformer models can recognize overarching relationships, such as how different regions of an image interact with each other or which features are particularly important for a specific task.

Although transformer models were originally developed for linguistic data (text), they have since proven to be extremely effective in processing image and video data. Here, the models analyze the spatial and temporal relationships between the pixels of an image or frames of a video. This allows them to recognize complex patterns and structures in visual material, making them ideal for tasks such as image segmentation and object recognition.

One advantage of the technology used herein is its flexibility. The transformer-based models described herein can be used permanently after the initial training and can continue to be used (e.g., without fine-tuning or retraining) even if the geometry of the plant, the design, the type or shape of the beverage containers, or any other optical properties in the plant environment change. No separate training is required for different filling systems or for different products in the transport region. This makes the models particularly robust against changes such as the introduction of new product types, varying light conditions, or different arrangements of conveyor and buffer segments.

The application of the various transformer-based AI approaches described herein in filling systems thus has several advantages compared to traditional systems.

The following section presents various possible implementations in the form of different systems and methods with which the advantages described above can be achieved. An exemplary architecture in which the models according to the disclosure can be implemented is shown in FIG. 8.

The systems described herein for generating control parameters for a machine line 100 all comprise a corresponding image source 102 for providing video frames of a recording of the machine line 100. This image source 102 is, for example, a video camera, the output of which is transmitted directly or indirectly, e.g., via a network and a cloud 110, to a corresponding computer apparatus 105.

The computer apparatus 105 comprises all necessary hardware components to run the corresponding transformer-technology-based models. In any case, this requires a suitable processor and memory in which the models are stored.

The computer apparatus 105 can be directly connected to the camera 102, or can be part of the cloud 110, or can be connected to the camera 102 via the cloud 110. The computer apparatus 105 can also be directly integrated into the camera 102 (smart camera). The computer apparatus 105 can furthermore be connected directly or indirectly (e.g., via the cloud 110) to the machine line 100, for example to transmit control parameters to the machine line 100. An operator 130 can operate the computer apparatus 120 using a graphical user interface 120.

According to a first exemplary implementation, several algorithms/models can be implemented which together can output the desired result (such as congestion localization, occupancy level, foreign object or anomaly detection, etc.) without any operator intervention.

Put simply, in the first exemplary implementation, the image source (e.g., the camera 102) and the computer apparatus 105 are used to acquire data. Subsequently, the selection of the desired object (e.g., bottle) and a boundary buffer or transport portion is determined only for the first frame. The algorithm will recognize the object in this frame and a tracker will automatically track the object along the transport route, thus calculating the occupancy level in each individual frame accordingly. This information can be forwarded to a control system to regulate the performance of the associated individual machines.

A segmentation model that is connected to a prompt encoder (such as a user input encoder) is used for this purpose. The prompt encoder allows the user to place one or more points and/or one or more boxes, or to enter text for a desired object, or an exemplary instance of a desired object, within a recorded frame that is to be segmented and tracked. Said prompt encoder includes the option to manually select the boundary, or it can be selected automatically in order to subsequently calculate its occupancy level.

The segmentation model is generally configured to receive video frames from the image source 102 and to segment and classify a large number of objects in a first video frame. Classification is not necessarily based on the type of object recognized, but is initially based on the fact that the model recognizes an object as an independent instance. Exemplary segmentation techniques that can be used in the disclosure are semantic segmentation, instance segmentation and panoptic segmentation, which differ in their objectives and application scenarios.

Semantic segmentation focuses on assigning each pixel of an image to a specific class, regardless of whether they are different instances of the same class. For example, in semantic segmentation, the entire region belonging to "cars" would be marked as one class, without differentiating between individual vehicles. This method is particularly useful for scenarios where capturing the spatial distribution of classes is crucial. Instance segmentation extends semantic segmentation by not only determining the class membership of each pixel, but also distinguishing between different instances of the same class. In an image with multiple vehicles, instance segmentation would, for example, mark each vehicle as a separate entity. Finally, panoptic segmentation combines the approaches of semantic and instance segmentation into a single framework. It segments both semantic classes for background regions (e.g., sky or roads) and individual instances of objects in the foreground (e.g., pedestrians or vehicles). This provides a complete depiction of the scene.

Unless otherwise mentioned, in the embodiments of the disclosure, semantic segmentation is used since it is generally not necessary to distinguish between different beverage containers on a conveyor belt if only an occupancy level or occupancy distribution is to be determined. However, the segmentation model can also distinguish between (normal) upright containers and (abnormal) fallen over/lying containers by dividing the "normal" and "abnormal" containers into two different classes. However, when changing varieties, e.g., from variety A to variety B, it may be necessary to differentiate variety A from variety B in order to, for example, always guarantee a gap between the varieties and to avoid mixing the varieties.

The segmentation model used herein was trained on a huge dataset containing an enormous number of labeled masks. Some of the data may be public and some may be private. The model can therefore make generalizations for each new input case/application case without having to fine-tune or retrain the model on a new dataset.

The prompt encoder is functionally linked to the segmentation model and is configured to make a selection of classified objects in the first video frame. The first classified object is a corresponding transport portion of the machine line. As described above, this selection can, for example, be made once by a user. In alternative embodiments, however, the model can also be trained in advance so that it automatically recognizes transport regions and directly assigns the attribute "transport region" to the corresponding class output by the segmentation model. A second classified object is a beverage container on the transport portion of the machine line. This does not necessarily mean that the model knows from the outset what a beverage container is or what it looks like, but the segmentation model recognizes that all beverage containers depicted in the frame belong to a single class. The prompt encoder allows the attribute "beverage container" to be assigned to this class. This is done either by the user or by automatic detection.

The segmentation model has thus created a mask for, for example, all beverage containers.

The segmentation model is then connected to a special tracker configured to identify and track all object instances from the class of selected classified objects in at least one subsequent video frame, or to track the created mask through the subsequent frames. Thus, at any time (e.g., for every frame), a state of the machine line can be determined and one or more corresponding control parameters for the machine line can be generated based on the determined state of the machine line.

In this method, the regulation of the performance of the individual machines is based on the number of detected/labeled pixels of the selected/desired object in relation to the total number of pixels in a specific buffer or transport portion, which has been selected manually or automatically.

The determined state of the machine line 100 can include various states of the transport system. Examples of this could be an occupancy level of the transport portion, a number of beverage containers on the transport portion, a congestion of the beverage containers on the transport portion, the end and/or the beginning of a congestion of a particular type and/or an anomaly of one or more beverage containers, such as a fallen over or damaged bottle or can.

According to an exemplary embodiment, the segmentation model comprises an image encoder that analyzes the input image, e.g., the video frame, and extracts its key functions (features). A point decoder can then be supplied with a grid of key points that consists of a 2D array and covers the entire image of the video frame. These points can be automatically assigned and encoded along with the video frame. Each key point can correspond to a potential position of an object or part thereof. The point decoder can use a pre-trained segmentation model to locate possible objects in the video frame. The information from the image encoder and the point decoder can be combined in a mask decoder to generate a mask that precisely outlines all objects in the image.

As previously described, the segmentation model is based on transformer technology, which uses self-attention mechanisms and positional encoding to capture global and contextual relationships between image regions in order to enable precise object recognition and segmentation. The segmentation model is trained on a dataset that comprises such a large number of labeled masks that the segmentation model can be used for a variety of input cases or application cases without having to retrain or fine-tune the segmentation model on a new dataset.

This implementation thus enables an automated workflow with zero intervention to provide the necessary information for controlling and regulating machine performance based on accurate occupancy level measurements, without the need to collect a new dataset, fine-tune the model for a specific/new case/task, or retrain it. This implementation also enables the automatic labeling of new datasets that would be used to train models for other zero-intervention tasks.

However, in one exemplary embodiment, it is also possible to use a traditional segmentation model which has been trained on a general dataset that has a standardized network architecture (convolutional neural network). This traditional segmentation model can then be retrained for new objects and/or lighting conditions, for example to be adapted to special containers and/or special environmental conditions.

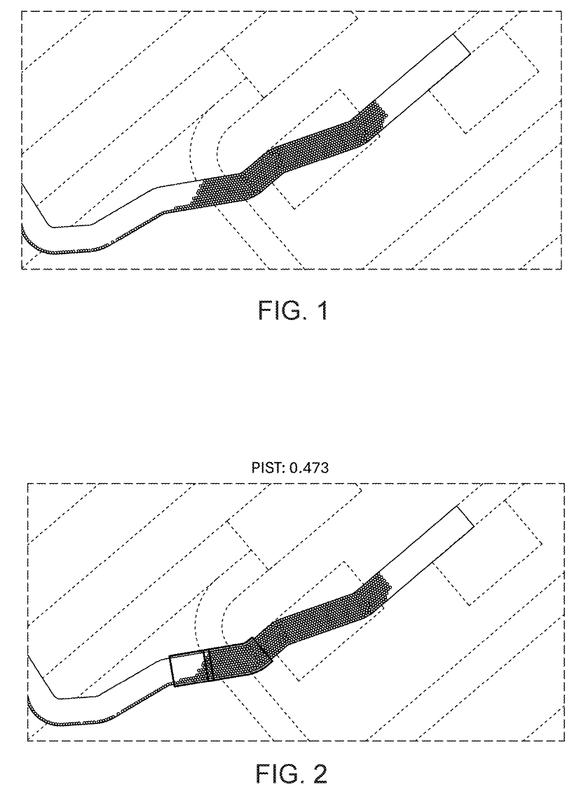

FIG. 1 shows an exemplary view of a machine line 100 from the perspective of a video camera 102 for image acquisition, which is mounted in a bird's eye view above the machine line 100. In the exemplary view of FIG. 1, the containers run along the surface of the transport system from left to right in the image. A congestion is already noticeable, for which it makes sense to adjust the corresponding machine speeds in order to reduce the congestion.

The first exemplary implementation will use the segmentation model to assign different classes to both the transport region and the individual bottles. By assigning the same class to all bottles or beverage containers, the computer apparatus 105 can determine for each frame how many corresponding object instances there are and thus determine exactly at any given time how many beverage containers are on the transport system. This allows an occupancy level to be determined at any given time, as shown in FIG. 2. The occupancy level is usually denoted by the parameter PIST and is 0.473 in the exemplary image of FIG. 4. This is a normalized value and therefore corresponds to 47.3%.

As can also be seen in FIG. 2, the occupancy level of a respective sub-portion can be calculated by automatically defined sub-portions along the transport system. As soon as one of the sub-portions within a congestion has an occupancy level of less than 1, the end of the congestion can be located.

According to a second, alternative implementation, a similarity model can be used instead of a segmentation model. This model substantially captures the similarity between the image and a desired selected object using the attention mechanism in the transformer.

In summary, the model consists of an image encoder that extracts features from different regions of an input image by dividing the image into a grid of squares or quadrangles to extract features for each square. Initially, the system uses the 102 image recording apparatus, such as a video camera 102 and an image processing computer 105, to acquire data. The objects and the associated buffer or transport portion are then automatically selected. The algorithm then counts the number of desired objects in a video frame. Accurate measurement of occupancy, congestion position, number of products, and outliers in the mass flow helps determine whether a machine should adjust its output or a conveyor should increase its speed in order to prevent congestions and container accumulation along the transport route or in specific zones. Furthermore, counting the products that reach specific regions allows for additional informed actions, including stopping operations if anomalies or outliers, such as falling bottles, are detected.

The model is fed with the desired objects, which are assigned automatically or manually, and encoded together with the image. The model then uses the extracted features to predict a density value for each square in the grid. This value substantially represents the "similarity" of this square to an object or part of an object. Higher density values indicate a higher probability that an object is located in that square.

In detail, this second implementation again comprises an image source 102 and a corresponding computer apparatus 105 for providing and executing a similarity model.

The similarity model is configured to receive a first video frame from the image source 102 and to define a visual representation of one or more target objects, such as a "correctly positioned beverage container." The video frame is then encoded along with the visual representation of the one or more target objects. Encoding can be done as follows.

The first video frame is first divided into a grid of rectangular regions, and features are extracted from each of the extracted rectangular regions. Features can include, for example, color regions, contours, shapes, edges, etc. A density value is then determined for each of the extracted rectangular regions. Such density value determination is based on a similarity of the corresponding rectangular region to the visual representation of the one or more target objects or part thereof. Next, a density map can be determined for the video frame.

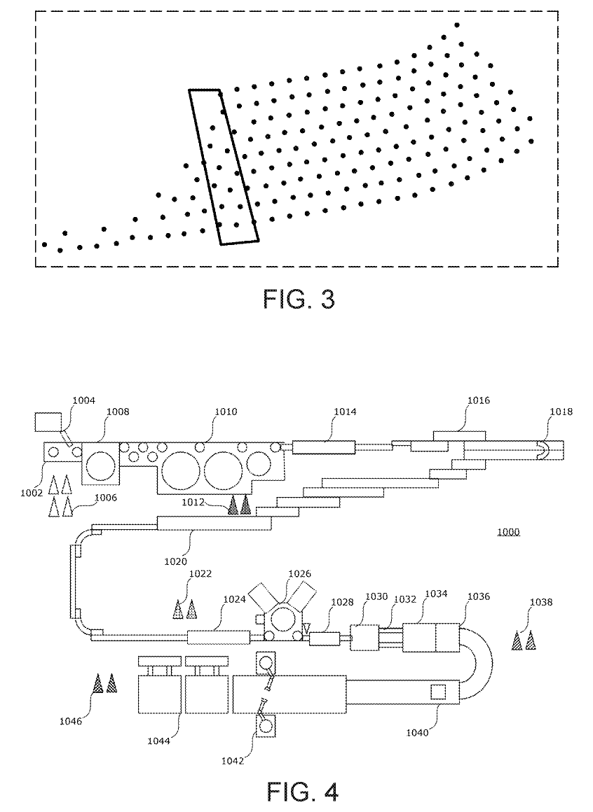

After encoding, the density map of the frame can be converted into a distribution of an actual number of target objects within a specific region of the machine line. An exemplary representation of a section of the density map is shown in FIG. 3. This density map can easily be used by an algorithm to determine the actual number of objects.

According to embodiments, the concept described above can be integrated into a logical system that automatically defines the desired objects in order to achieve zero intervention. All that is required is to provide the model with video or live stream frames, and the model will begin counting and creating a density map for the mass flow without any intervention being needed.

Thus, based on the actual number of target objects within the defined region of the machine line, a state of the machine line can be determined and, if necessary, a corresponding control parameter for the machine line can be generated based on the determined state of the machine line.

For example, after counting the objects, the occupancy level can be calculated based on the number of objects in relation to the maximum number of objects in a specific/desired region. Congestion detection and localization is achieved through a developed concept that analyzes the number of objects and identifies the location of the congestion, as can be seen in particular in FIG. 2.

Furthermore, the model can be fed with "outliers," such as visual representations of broken or fallen over containers or foreign objects, in order to identify and label them accordingly. In this method, the output power of the individual machines is controlled based on the number of objects found in each buffer or transport portion by similarity mapping and pixel-based object counting.

This second implementation enables an automated, non-interventional workflow for providing the necessary information for controlling and regulating machine performance based on precise measures such as occupancy, congestion location, number of products and outliers, without the need to collect a new dataset, fine-tune the model or retrain it for a specific/new case/task.

The system provides these functions solely based on visual inputs (video/live stream images). This idea goes beyond simply recognizing a single object type and can potentially identify various objects such as containers, closures, and packages within a scene. Furthermore, the model, in conjunction with a camera, enables the monitoring and control of various processes and applications – both live and offline – in various industries.

It is possible to imagine application in mass transport, machine flow monitoring in buffer systems, or container and pallet transport tracking. The concept can even be used to monitor the position of AGVs or robots and to help with route planning. Additionally, it can be used to secure security zones by detecting the intrusion of objects or people. This wide range of applications underlines the model's potential for solving real problems. Furthermore, it can track and regulate the number of different auxiliary devices within a supply system, such as closures, preform trays, boxes, promotional items, and even empty containers stored in buffers. This comprehensive object recognition and monitoring capability has the potential to increase efficiency and security in numerous industries.

According to a third, alternative implementation, a system for generating control parameters for a machine line 100 is provided using pixel-based object counting, which is based on an object recognition model. To start the system of the third implementation, an image recording apparatus 102 (such as a video camera) and image processing computer 105 are again used to acquire data. The objects and the associated buffer or transport portion are then automatically selected. Put simply, the algorithm counts the number of desired objects in a frame.

The model consists of an image encoder that analyzes the input image and extracts its key functions (features). A point decoder is then supplied with a grid of key points that consists of a 2D array and covers the entire image. These points are automatically assigned and encoded along with the image. Each key point can correspond to a potential position of an object or part thereof. The point decoder can use a pre-trained segmentation model to locate possible objects in the video frame.

They are then converted into a format that the model can work with. The information from the image and the point encoders is combined in a mask decoder to generate a mask that precisely outlines all objects in the image.

The model can provide hierarchical masks structured as i) masks that include a complete object, for example a complete beverage container, ii) masks that include parts of an object, for example a bottle neck or bottle body, and iii) masks for details, for example labels or screw caps of a bottle.

This is followed by a classification step to combine each mask within its own bounding region/box and to discard or merge sub-objects and very small components within the overall object. This classification and filtering of the created masks is based on a selection of a representation of one or more target objects. The filtered classification selects only this class of the one or more target objects.

Finally, a number of target objects is determined based on the filtered classification, and a state of the machine line 100 is determined based on the number of target objects, in order to then generate one or more control parameters for the machine line based on the determined state of the machine line.

The model is trained once on a large dataset, which allows the model to generalize well to new images/objects. Additionally, this implementation automatically uses grid key points, making it a zero-intervention solution where only video or live stream images need to be submitted to the model in order to mask mass flow and transport without any need for further training or intervention.

In this way, the objects in each image frame are recognized and counted. After counting the objects, occupancy can be calculated based on the number of objects in relation to the maximum number of objects in a specific/desired region. Congestion detection and localization is achieved through a developed concept that analyzes the number of objects and identifies the location of the congestion. Furthermore, the model can be fed with outliers in order to identify and label them accordingly. In this method, the output power of the individual machines is controlled based on the number of objects found for each buffer or transport portion by pixel-based object recognition.

Thus, in this implementation too, accurate measurement of occupancy, congestion detection, number of products, and outliers in the mass flow helps to determine whether a machine should adjust its output power or a conveyor should increase its speed in order to prevent congestions and the accumulation of containers along the transport or in specific zones. Furthermore, counting the products that reach specific regions allows for additional informed actions, including interrupting operations upon detecting anomalies/outliers, such as bottles that are falling over.

In the following FIGS. 4 to 7, various exemplary plant configurations for different bottle filling plants are described in which the disclosure or at least parts and aspects of the disclosure can be implemented. The description of FIGS. 4 to 7 is intended only to provide a general overview of machines for which state data can be collected, on the basis of which the LLM can process user queries.

FIG. 4 shows an exemplary plant configuration 1000 for PET bottles or PET containers and adhesive containers. As can be seen in FIG. 4, the plant configuration 1000 comprises a wide variety of modules, which form a line at the end of which the ready-filled PET containers are dispensed in the form of a bundle on pallets. Some of the modules and machines can be optional, and the disclosure is not limited to the exact shape and arrangement of the plant configurations.

The plant configuration 1000 comprises a furnace 1002 for preforms, a preform sorting system with a feeding machine 1004, and a blow-molding machine 1008. Modules 1002, 1004, and 1008 form in general a stretch blow-molding machine in which PET containers are manufactured and formed from a raw material. The produced PET containers are forwarded to a filler 1010 in which the bottles are filled. The filler can optionally comprise a rinser. Various particles such as dust, cardboard, or remains of wooden pallets can collect in the preforms during storage or transport. These can be removed with the rinser. At the end of the filler, a closer can be arranged, using which the PET containers are closed after filling.

Optionally, the plant configuration 1000 can, after the filler 1010, comprise a rotating apparatus, which is used for hot filling of the PET containers. The filled PET containers are guided to a separator 1020 and further to a drying apparatus 1024 in which the PET containers are dried via one or more conveyor belts 1016, which can also comprise a buffer 1018 for intermediate loading of filled containers.

After drying, the PET containers are conveyed to a labeling machine 1026. The labeling machine 1026 can be configured for various labeling techniques such as labeling using hot glue, cold glue, self-adhesive labels, or sleeves. After printing or labeling the PET containers, the PET containers are passed through a second drying apparatus 1028, a line distributor 1030, conveyor belts 1032, adhesive container production 1034, and a curing section to a handle applicator. In adhesive packaging production 1034, the PET containers are grouped together in certain group sizes and packaged into a pack such as a “six-pack.” In the handle applicator, a carrying handle is attached to the pack, which allows the pack to be carried comfortably. The finished packs are then accordingly arranged by a robot 1042 for layer production and packed on pallets by a palletizer 1044.

In the plant configuration 1000, so-called format trolleys or format racks can be arranged on various modules and machines in order to provide quickly changeable format sets for short changeover times and automatic tool exchange. Examples of format trolleys are the format trolley 1006 for the blow-molding machine 1008, the format trolley 1012 for the filler 1010, the format trolley 1022 for the labeling machine 1026, the format trolley 1038 for the adhesive packaging production 1034, and the format trolley 1046 for the palletizer 1044.

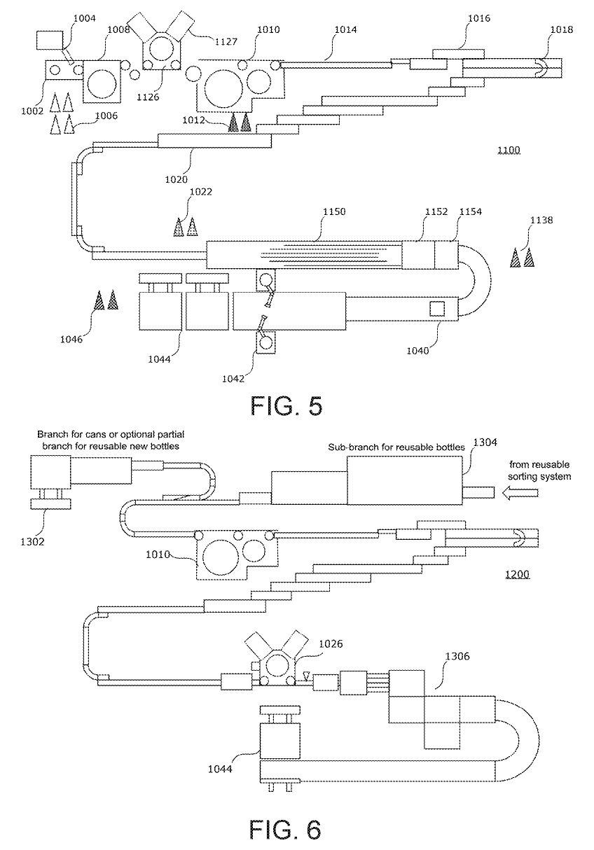

FIG. 5 shows another exemplary plant configuration 1100 for PET containers and shrink packers. The plant 1100 in FIG. 5 comprises many of the modules and machines from the plant configuration 1000 in FIG. 4, but there are some differences. The description of the modules that have already been described in connection with FIG. 4 is therefore omitted for FIG. 5.

A key difference between the two exemplary plant configurations 1000 and 1100 is that the labeling machine 1126 with the labeling modules 1127 can already be installed after the blow-molding machine 1008 and before the filler 1008. For this purpose, the plant configuration 1100 can comprise six transport lanes 1150 into which the PET containers can be pushed. After the PET containers have been correspondingly pushed into one of the six lanes 1150, they are conveyed into the film wrapping module 1152 and then into the shrink tunnel 1154.

FIG. 6 shows an exemplary plant configuration 1200 for cans or glass bottles. The exemplary plant configuration 1200 from FIG. 6 again has some similarities to the plant configurations 1000 and 1100 from FIGS. 4 and 5, and the description of the plant configuration is therefore limited to the differences between the plant configurations.

As shown in FIG. 6, the exemplary plant configuration can comprise two separate feeds. A first feed, on the left in FIG. 6, shows a branch for cans or, optionally, a partial branch for reusable new bottles. The containers, i.e., cans or new bottles, are fed from a depalletizer 1302 into the machine, where they are guided via conveyor belts to the filler 1010. A second feed, on the right in FIG. 6, shows a partial branch for reusable bottles, which are introduced into the plant from a reusable sorting plant (not shown).

In the case in which the reusable bottles that have already been used are introduced into the plant 1200 via the sub-branch for reusable bottles, the reusable bottles first pass through the cleaning machine or washing machine 1304. Another possible difference of the exemplary plant configuration 1200 is the transfer packer 1306 after the labeling machine 1026. The transfer packer can sort the bottles or cans into a carton clip application or into boxes, or both.

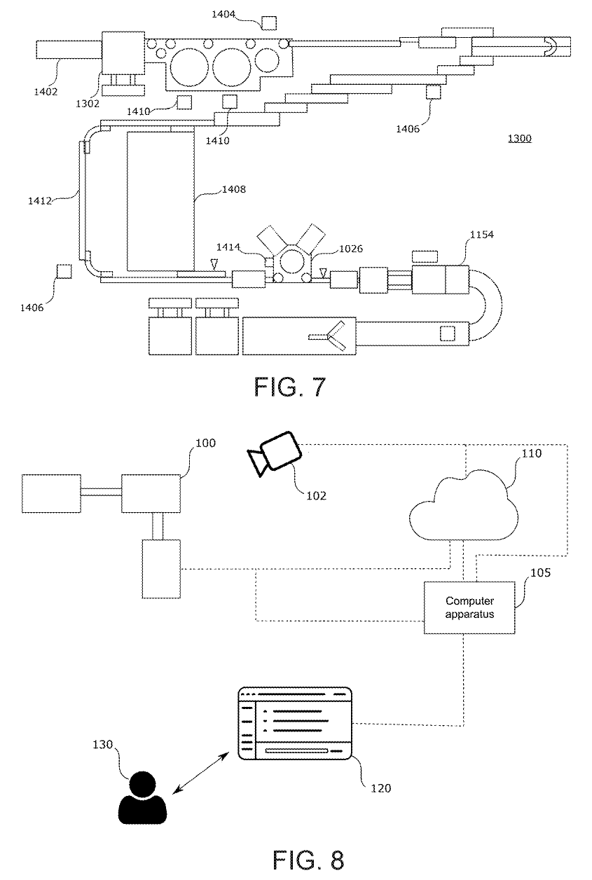

FIG. 7 shows an exemplary plant configuration 1300 for cans, in which the elements already described in the other plant configurations are not described. The cans in the plant configuration 1300 are introduced from a magazine 1402 with cans into the depalletizer 1302. The cans, after they have passed through the filler and are filled, are closed by a closure magazine 1404 and are then transported further along the plant 1400 via the conveyor belts as described above.

The optional pasteurizer 1408 can be circumvented via the bypass 1412 if it is not required. In the pasteurizer 1408, the freshly filled products can be pasteurized for preservation.

In contrast to the plant configurations 1000, 1100, and 1200, the exemplary plant configuration 1300 shows various tanks for corresponding consumables, such as the tanks 1410 with rinsing liquid and/or the filling product, and the tanks 1406 with belt lubricant. These tanks can also be contained in the above-described exemplary plant configurations. For example, the chemical products 106 that are fed from the mixer 110 to the machines can be stored in the tanks 1406 and 1410.

1. A system for generating control parameters for a machine line, wherein the system comprises:
the machine line;
an image source for providing video frames, wherein the video frames are from a recording of the machine line; and
a computer apparatus comprising a processor and a memory connected to the processor, wherein the computer apparatus is configured to provide and execute:
a segmentation model that receives video frames from the image source and is configured to segment and classify a large number of objects in a first video frame;
a prompt encoder that is functionally linked to the segmentation model and is configured to make a selection of classified objects in the first video frame, wherein a first classified object is a transport portion of the machine line, and wherein a second classified object is a beverage container on the transport portion of the machine line; and
a tracker configured to identify and track all object instances from the class of selected classified objects in at least one subsequent video frame;
wherein the processor is further configured to:
determine a state of the machine line based on the tracker data; and
generate one or more control parameters for the machine line based on the determined state of the machine line.

2. The system according to claim 1, wherein the segmentation model comprises:
an image encoder configured to analyze the first video frame and extract key functions;
a point decoder supplied with a grid of key points that consists of a 2D array and covers the first video frame, wherein:
the key points are automatically assigned and encoded along with the first video frame;
each key point corresponds to a potential position of an object or part thereof; and
the point decoder uses a pre-trained segmentation model to locate possible objects in the video frame; and
a mask decoder configured to combine the information from the image encoder and the point decoder to generate a mask that outlines all objects in the video frame.

3. The system according to claim 1, wherein the determined state of the machine line comprises:
an occupancy level of the transport portion; and/or
a number of beverage containers on the transport portion; and/or
a congestion of the beverage containers on the transport portion; and/or
an anomaly of one or more beverage containers.

4. The system according to claim 1, wherein the prompt encoder is configured to receive a user input, wherein the user input selects one or more classified objects.

5. The system according to claim 1, wherein:
the segmentation model is based on transformer technology, wherein self-attention mechanisms and positional encoding are used to capture global and contextual relationships between image regions in order to enable precise object recognition and segmentation, and
the segmentation model was trained on a dataset that comprises a number of labeled masks, wherein the dataset is so large that the segmentation model can be used for a variety of input cases or application cases without having to retrain or fine-tune the segmentation model on a new dataset.

6. A system for generating control parameters for a machine line, wherein the system comprises:
the machine line;
an image source for providing video frames, wherein the video frames are from a recording of the machine line; and
a computer apparatus comprising a processor and a memory connected to the processor, wherein the computer apparatus is configured to provide and execute a similarity model comprising an image encoder, wherein the similarity model is configured to:
receive a first video frame from the image source;
define a visual representation of one or more target objects;
encode the first video frame along with the visual representation of the one or more target objects, wherein encoding comprises:
dividing the first video frame into a grid of rectangular regions,
extracting features from each of the divided rectangular regions,
determining a density value for each of the divided rectangular regions based on a similarity of the corresponding rectangular region to the visual representation of the one or more target objects or part thereof, and
creating a density map for the first video frame,
convert the density map of the first video frame into a distribution of an actual number of target objects within a specific region of the machine line;
determine a state of the machine line based on the actual number of target objects within the specific region of the machine line; and
generate one or more control parameters for the machine line based on the determined state of the machine line.

7. The system according to claim 6, wherein the determined state of the machine line comprises:
an occupancy level of the transport portion; and/or
a number of beverage containers on the transport portion; and/or
a congestion of the beverage containers on the transport portion; and/or
an anomaly of one or more beverage containers.

8. The system according to claim 6, wherein:
the target object is a correctly positioned beverage container on the transport portion of the machine line; and/or
wherein the target object is a beverage container in an incorrect position on the transport portion of the machine line; and/or
wherein the target object is a foreign object on the transport portion of the machine line.

9. The system according to claim 6, wherein:
the similarity model is based on transformer technology, wherein self-attention mechanisms and positional encoding are used to capture global and contextual relationships between image regions in order to enable precise object recognition and segmentation, and
the similarity model was trained on a dataset that comprises a number of labeled masks, wherein the dataset is so large that the similarity model can be used for a variety of input cases or application cases without having to retrain or fine-tune the similarity model on a new dataset.

10. A system for generating control parameters for a machine line, wherein the system comprises:
the machine line;
an image source for providing video frames, wherein the video frames are from a recording of the machine line;
a computer apparatus comprising a processor and a memory connected to the processor, wherein the computer apparatus is configured to provide and execute an object recognition model, wherein the object recognition model is configured to:
receive a first video frame from the image source,
analyze the first video frame using an image encoder in order to extract features from the video frame,
overlay the first video frame with key points, using a point decoder, in a 2D grid structure, wherein each key point corresponds to a potential position of an object or part thereof, wherein the point decoder uses a pre-trained segmentation model to locate possible objects in the video frame,
merge, using a mask decoder, the extracted features from the image encoder and the key points to create pixel-accurate masks of recognized objects in the first video frame,
classify and filter the created masks based on a selection of a representation of one or more target objects comprises, and wherein the filtered classification selects only the class of the one or more target objects,
determine a number of target objects based on the filtered classification and determine a state of the machine line based on the number of target objects; and
generate one or more control parameters for the machine line based on the determined state of the machine line.

11. The system according to claim 10, wherein the masks are hierarchically structured as:
masks that comprise a complete object,
masks that include parts of an object, and
masks for details.

12. The system according to claim 10, wherein the determined state of the machine line comprises:
an occupancy level of the transport portion; and/or
a number of beverage containers on the transport portion; and/or
a congestion of the beverage containers on the transport portion; and/or
an anomaly of one or more beverage containers.

13. A method for generating control parameters for a machine line, wherein the method comprises:
segmenting and classifying a large number of objects in a first video frame of a video stream, wherein the video stream is from a recording of the machine line;
making a selection of classified objects in the first video frame, wherein a first classified object is a transport portion of the machine line, and wherein a second classified object is a beverage container on the transport portion of the machine line;
identifying and tracking all object instances from the class of selected classified objects in at least one subsequent video frame of the video stream;
determining a state of the machine line based on the tracked object instances, and
generating one or more control parameters for the machine line based on the determined state of the machine line.

14. A method for generating control parameters for a machine line, wherein the method comprises:
receiving a first video frame of a video stream, wherein the video stream is from a recording of the machine line;
defining a visual representation of one or more target objects;
encoding the first video frame along with the visual representation of the one or more target objects, wherein encoding comprises:
dividing the first video frame into a grid of rectangular regions,
extracting features from each of the divided rectangular regions,
determining a density value for each of the divided rectangular regions based on a similarity of the corresponding rectangular region to the visual representation of the one or more target objects or part thereof, and
creating a density map for the first video frame,
converting the density map of the first video frame into a distribution of an actual number of target objects within a specific region of the machine line;
determining a state of the machine line based on the actual number of target objects within the specific region of the machine line; and
generating one or more control parameters for the machine line based on the determined state of the machine line.

15. A method for generating control parameters for a machine line using pixel-based object counting, wherein the method comprises:
receiving a first video frame of a video stream, wherein the video stream is from a recording of the machine line,
analyzing the first video frame using an image encoder in order to extract features from the video frame,
overlaying the first video frame with key points, using a point decoder, in a 2D grid structure, wherein each key point corresponds to a potential position of an object or part thereof, wherein the point decoder uses a pre-trained segmentation model to locate possible objects in the video frame,
merging, using a mask decoder, the extracted features from the image encoder and the key points to create pixel-accurate masks of recognized objects in the first video frame,
classifying and filtering the created masks based on a user input, wherein the user input includes a selection of a representation of one or more target objects, and wherein the filtered classification selects only the class of the one or more target objects,
determining a number of target objects based on the filtered classification and determining a state of the machine line based on the number of target objects; and
generating one or more control parameters for the machine line based on the determined state of the machine line.

16. The system according to claim 1, wherein the machine line is configured for filling and packaging food and/or beverages.

17. The system according to claim 6, wherein the machine line is configured for filling and packaging food and/or beverages.

18. The system according to claim 10, wherein the machine line is configured for filling and packaging food and/or beverages.

19. The system according to claim 11, wherein the complete object is a complete beverage container.

20. The system according to claim 11, wherein the parts of the object comprise a bottle neck or bottle body.
